(19) United States
(12) Patent Application Publication
(10) Pub. No.: US 2006/0155848 A1
(43) Pub. Date: Jul. 13, 2006

(54) Workflow decision management including identifying user reaction to workflows

(76) Inventors: William A. Brown, Raleigh, NC (US); Richard William Muirhead, Tyler, TX (US); Francis Xavier Reddington, Sarasota, FL (US)

Correspondence Address: INTERNATIONAL CORP (BLF), c/o BIGGERS & OHANIAN, LLP, P.O. BOX 1469, AUSTIN, TX, 78767-1469, US

(21) Appl. No.: 11/032,337

(22) Filed: Jan. 10, 2005

(51) Int. Cl. G06F 15/173

(52) U.S. Cl. 709/224

(57) ABSTRACT

Methods, systems, and computer program products are provided for workflow decision management. Embodiments typically include maintaining a device state history; identifying a device usage pattern in dependence upon the device state history; identifying a derived scenario in dependence upon the device usage pattern. In typical embodiments the derived scenario has a tolerance. Embodiments also include identifying a workflow in dependence upon the derived scenario; executing the workflow in dependence upon the tolerance; and identifying a user reaction to the execution of the workflow.

### BACKGROUND OF THE INVENTION

1. Field of the Invention

The field of the invention is data processing, or, more specifically, methods, systems, and products for workflow decision management.

2. Description Of Related Art

Conventional networks contain various networked devices. User's often use the various devices, or adjust particular settings of the devices, in accordance with consistent patterns and scenarios of device usage. Despite routinely using devices according to these consistent patterns and scenarios of device usage, conventional networked devices still often require user intervention to change attribute values of a device. It would be advantageous if there were a method of workflow decision management that used workflows to change in values of device attributes in a network in dependence upon identified patterns of usage and identified scenarios that did not require user intervention. It would also be advantageous if there were a method to evaluate the effectiveness of the execution of workflows.

### SUMMARY OF THE INVENTION

Methods, systems, and computer program products are provided for workflow decision management. Embodiments typically include maintaining a device state history, identifying a device usage pattern in dependence upon the device state history, identifying a derived scenario in dependence upon the device usage pattern. In typical embodiments the derived scenario has a tolerance. Embodiments also include identifying a workflow in dependence upon the derived scenario executing the workflow in dependence upon the tolerance and identifying a user reaction to the execution of the workflow.

In many embodiments, identifying a user reaction to the execution of the workflow is carried out by recording in a device state history a device attribute value set by executing the workflow, reading a current value of the device attribute a predetermined period of time after executing the workflow, and comparing the device attribute value set by executing the workflow and the current value of the device attribute a predetermined period of time after executing the workflow. Some embodiments also include recording an indication of a negative user reaction in a user reaction log.

Many embodiments include presenting the user reaction log to a user, receiving an editing instruction from the user, and editing a derived scenario in dependence upon the editing instruction. Some embodiments include presenting the user reaction log to a user, receiving an editing instruction from the user, and editing a tolerance in dependence upon the editing instruction. Some embodiments include presenting the user reaction log to a user, receiving an editing instruction from the user, and editing a workflow in dependence upon the editing instruction.

In typical embodiments, maintaining a device state history includes recording a plurality of attribute values for a device. In many embodiments, identifying a device usage pattern in dependence upon the device state history includes comparing the device state history with a plurality of device usage patterns records. In many embodiments, identifying a derived scenario in dependence upon the device usage pattern includes retrieving a derived scenario ID from a derived scenario table.

The foregoing and other objects, features and advantages of the invention will be apparent from the following more particular descriptions of exemplary embodiments of the invention as illustrated in the accompanying drawings wherein like reference numbers generally represent like parts of exemplary embodiments of the invention.

### BRIEF DESCRIPTION OF THE DRAWINGS

FIG. 1 depicts an exemplary data processing system capable of workflow decision management according to embodiments of the present invention.

FIG. 2 sets forth a block diagram of an exemplary device useful in implementing workflow decision management according to embodiments of the present invention.

FIGS. 3 is a block diagram illustrating exemplary data structures useful in implementing methods of workflow decision management according to aspects of the present invention.

FIG. 4 is a block diagrams illustrating more exemplary data structures useful in implementing methods of workflow decision management according to aspects of the present invention

FIG. 5 is a block diagram illustrating an exemplary relationship among the data structures of FIGS. 3 and 4.

FIG. 6 sets forth a data flow diagram illustrating an exemplary method for workflow decision management.

FIG. 7 sets forth a data flow diagram illustrating an exemplary method for workflow decision management.

FIG. 8 sets forth a data flow diagram illustrating an exemplary method for identifying a user reaction to the execution of the workflow.

FIG. 9 sets forth a method of workflow decision management that includes recording an indication of a negative user reaction in a user reaction log.

### DETAILED DESCRIPTION OF EXEMPLARY EMBODIMENTS

### Introduction

The present invention is described to a large extent in this specification in terms of methods for workflow decision management. Persons skilled in the art, however, will recognize that any computer system that includes suitable programming means for operating in accordance with the disclosed methods also falls well within the scope of the present invention. Suitable programming means include any means for directing a computer system to execute the steps of the method of the invention, including for example, systems comprised of processing units and arithmetic-logic circuits coupled to computer memory, which systems have the capability of storing in computer memory, which computer memory includes electronic circuits configured to store data and program instructions, programmed steps of the method of the invention for execution by a processing unit.

The invention also may be embodied in a computer program product, such as a diskette or other recording medium, for use with any suitable data processing system. Embodiments of a computer program product may be implemented by use of any recording medium for machine-readable information, including magnetic media, optical media, or other suitable media. Persons skilled in the art will immediately recognize that any computer system having suitable programming means will be capable of executing the steps of the method of the invention as embodied in a program product. Persons skilled in the art will recognize immediately that, although most of the exemplary embodiments described in this specification are oriented to software installed and executing on computer hardware, nevertheless, alternative embodiments implemented as firmware or as hardware are well within the scope of the present invention.

### Definitions

“802.11” refers to a family of specifications developed by the IEEE for wireless LAN technology. 802.11 specifies an over-the-air interface between a wireless client and a base station or between two wireless clients.

“API” is an abbreviation for “application programming interface.” An API is a set of routines, protocols, and tools for building software applications.

“Bluetooth” refers to an industrial specification for a short-range radio technology for RF couplings among client devices and between client devices and resources on a LAN or other network. An administrative body called the Bluetooth Special Interest Group tests and qualifies devices as Bluetooth compliant. The Bluetooth specification consists of a ‘Foundation Core,’ which provides design specifications, and a ‘Foundation Profile,’ which provides interoperability guidelines.

“CEBus” is an abbreviation for Consumer Electronics Bus. CEBus is an open international standard for controlling devices over different media such as power line, radio frequency (RF), infrared (IR), coaxial cable, twisted pair, fiber optics and audio/video. The CEBus standard is promulgated by the Consumer Electronic Manufacturers Association (CEMA), a sector of the Electronics Industries Association (EIA) and described in 12 standards: the ANSIIEIA-600 series. The CEBus standard describes a physical design and topology of network media, a protocol for message generation, and a common application language (“CAL”). The CEBus specification is available for download at http://www.cebus.org.

CEBus provides a Common Application Language (CAL) defined in EIA 600.81 that uses an object-oriented model to provide interoperability between diverse devices in a networked environment. The CAL specification defines a set of classes that provide an interface to the internal operations of these disparate networked devices. If a function or feature cannot be mapped well to one of the classes defined in the CAL specification, the CAL specification has set aside a specific range of class identifiers for defining special classes.

CAL objects have two important attributes Instance Variables and Methods. Instance Variables contain information about a particular CAL object such as Boolean indications, numeric information, character-string information, and other data. Boolean Instance Variables can only be set to TRUE or FALSE. As the name implies, numeric Instance Variables are intended for storage of numbers. The character-string type Instance Variables provide storage of text. And other data-type Instance Variables provide storage of other information as a single-dimensioned array of one or more elements, each element containing the same number of one or more bytes.

Access to the information contained in CAL Instance Variables is accomplished through a set of member methods specific to that object. Examples of common methods include: setOn, setOff, setValue, getValue, setArray and getArray. Not all methods are appropriate for each Instance Variable type. For example, a setOn method is intended for manipulating Boolean Instance Variables and is therefore undefined for an Instance Variable of the character-string type.

“Coupled for data communications” means any form of data communications, wireless, 802.11b, Bluetooth, infrared, radio, internet protocols, HTTP protocols, email protocols, networked, direct connections, dedicated phone lines, dial-ups, serial connections with RS-232 (EIA232) or Universal Serial Buses, hard-wired parallel port connections, network connections according to the Power Line Protocol, and other forms of connection for data communications as will occur to those of skill in the art. Couplings for data communications include networked couplings for data communications. Examples of networks useful with various embodiments of the invention include cable networks, intranets, extranets, internets, local area networks, wide area networks, and other network arrangements as will occur to those of skill in the art. The use of any networked coupling among television channels, cable channels, video providers, telecommunications sources, and the like, is well within the scope of the present invention.

“HAVi” stands for ‘Home Audio Video interoperability,’ the name of a vendor-neutral audio-video standard particularly for home entertainment environments. HAVi allows different home entertainment and communication devices (such as VCRs, televisions, stereos, security systems, and video monitors) to be networked together and controlled from one primary device, such as a services gateway, PC, or television. Using IEEE 1394, the ‘Firewire’ specification, as the interconnection medium, HAVi allows products from different vendors to comply with one another based on defined connection and communication protocols and APIs. Services provided by HAVi's distributed application system include an addressing scheme and message transfer, lookup for discovering resources, posting and receiving local or remote events, and streaming and controlling isochronous data streams.

“HomePlug” stands for The HomePlug Powerline Alliance. HomePlug is a not-for-profit corporation formed to provide a forum for the creation of open specifications for high speed home powerline networking products and services. The HomePlug specification is designed for delivery of Internet communications and multimedia to homes through the home power outlet using powerline networking standards.

The HomePlug protocol allows HomePlug-enabled devices to communicate across powerlines using Radio Frequency signals (RF). The HomePlug protocol uses Orthogonal Frequency Division Multiplexing (OFDM) to split the RF signal into multiple smaller sub-signals that are then transmitted from one HomPlug enabled-device to another HomePlug-enabled device at different frequencies across the powerline.

“HTTP” stands for ‘HyperText Transport Protocol,’ the standard data communications protocol of the World Wide Web.

“ID” abbreviates “identification” as used by convention in this specification with nouns represented in data elements, so that ‘user ID’ refers to a user identification and ‘userID’ is the name of a data element in which is stored a user identification.

“LAN” is an abbreviation for “local area network.” A LAN is a computer network that spans a relatively small area. Many LANs are confined to a single building or group of buildings. However, one LAN can be connected to other LANs over any distance via telephone lines and radio waves. A system of LANs connected in this way is called a wide-area network (WAN). The Internet is an example of a WAN.

“LonWorks” is a networking platform available from Echelon®. Lon Works is currently used in various network applications such as appliance control and lighting control. The LonWorks networking platform uses a protocol called “LonTalk” that is embedded within a “Neuron Chip” installed within Lon Works-enabled devices.

The Neuron Chip is a system-on-a-chip with multiple processors, read-write and read-only memory (RAM and ROM), and communication and I/O subsystems. The read-only memory contains an operating system, the LonTalk protocol, and an I/O function library. The chip has non-volatile memory for configuration data and for application programs, which can be downloaded over a LonWorks network to the device. The Neuron Chip provides the first 6 layers of the standard OSI network model. That is, the Neuron Chip provides the physical layer, the data link layer, the network layer, the transport layer, the session layer, and the presentation layer.

The Neuron Chip does not provide the application layer programming. Applications for LonWorks networks are written in a programming language called “Neuron C.” Applications written in Neuron C are typically event-driven, and therefore, result in reduced traffic on the network.

“OSGI” refers to the Open Services Gateway Initiative, an industry organization developing specifications for services gateways, including specifications for delivery of service bundles, software middleware providing compliant data communications and services through services gateways. The Open Services Gateway specification is a java based application layer framework that gives service providers, network operator device makers, and appliance manufacturer's vendor neutral application and device layer APIs and functions.

“USB” is an abbreviation for “universal serial bus.” USB is an external bus standard that supports data transfer rates of 12 Mbps. A single USB port can be used to connect up to 127 peripheral devices, such as mice, modems, and keyboards. USB also supports Plug-and-Play installation and hot plugging.

“WAP” refers to the Wireless Application Protocol, a protocol for use with handheld wireless devices. Examples of wireless devices useful with WAP include mobile phones, pagers, two-way radios, and hand-held computers. WAP supports many wireless networks, and WAP is supported by many operating systems. Operating systems specifically engineered for handheld devices include PalmOS, EPOC, Windows CE, FLEXOS, OS/9, and JavaOS. WAP devices that use displays and access the Internet run “microbrowsers.” The microbrowsers use small file sizes that can accommodate the low memory constraints of handheld devices and the low-bandwidth constraints of wireless networks.

The “X-10” means the X-10 protocol. Typical X-10 enabled devices communicate across AC powerline wiring, such as existing AC wiring in a home, using an X-10 transmitter and an X-10receiver. The X-10 transmitter and the X-10 receiver use Radio Frequency (RF) signals to exchange digital information. The X-10 transmitter and the X-10 receiver communicate with short RF bursts which represent digital information.

In the X-10 protocol, data is sent in data strings called frames. The frame begins with a 4 bit start code designated as “1110.” Following the start code, the frame identifies a particular domain, such as house, with a 4 bit “house code,” and identifies a device within that domain with a 4 bit “devices code.” The frame also includes a command string of 8 bits identifying a particular preset command such as “on,” “off,” “dim,” “bright,” “status on,” “status off,” and “status request.”

### Exemplary Architecture for Workflow Decision Management

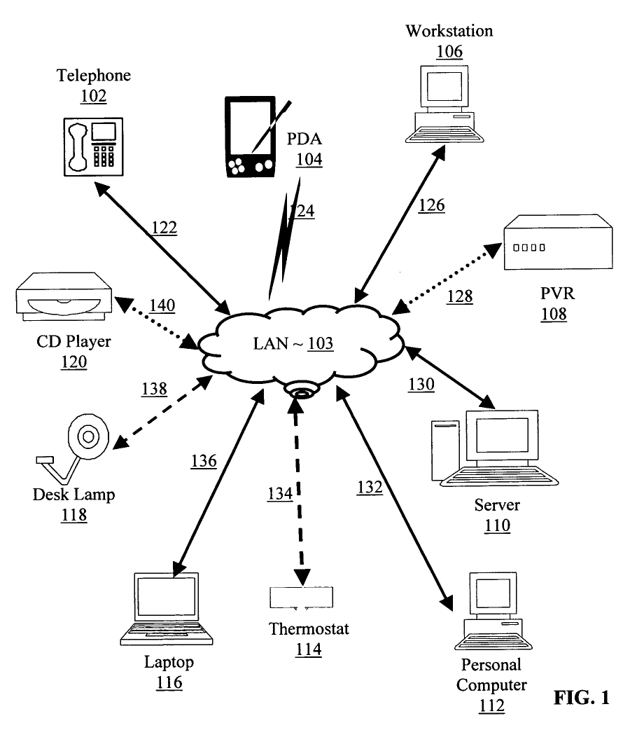

Exemplary methods, systems, and products for workflow decision management, are now explained with reference to the accompanying drawings, beginning with FIG. 1. FIG. 1 depicts an exemplary data processing system capable of workflow decision management according to embodiments of the present invention. The exemplary system of FIG. 1 includes a number of workflow decision management compliant devices capable of implementing workflow decision management according to embodiments of the present invention that are connected for data communications through a local area network (“LAN”)(103). In the example of FIG. 1, the exemplary workflow decision management compliant devices include a personal digital assistant (“PDA”) (104), a computer workstation (106), a personal video recorder (108), a server (110), personal computer (112), a thermostat (114), a laptop (116), a desk lamp (118), a compact disc player (120), and a telephone (102) are coupled for data communications through a LAN. The network connection aspect of the architecture of FIG. 1 is only for explanation, not for limitation. In fact, systems for workflow decision management according to embodiments of the present invention may implemented with LANs, WANs, intranets, internets, the Internet, webs, the World Wide Web itself, or other connections as will occur to those of skill in the art. Such networks are media that may be used to provide data communications connections between various devices and computers connected together within an overall data processing system.

In the example of FIG. 1, the PDA (104) is coupled for data communications to the LAN (103) through a wireless link (124). The workstation (106), the server (110), the personal computer (112), the laptop (116), and the telephone (102) are coupled for data communications to the LAN through twisted pair wireline connections (126, 130, 132, 136, 122). The personal video recorder (108) and the compact disc player (120) are coupled for data communications to the LAN through a coaxial cable wireline connection (128, 140). The thermostat (114) and the desk lamp (118) are coupled for data communications to the LAN through a powerline connection (134, 138).

The exemplary devices of FIG. 1 are capable of reporting current values of supported device attributes and the exemplary devices of FIG. 1 are also capable of receiving messages from other devices instructing the device to change values of supported attributes. The exemplary system of FIG. 1 is capable generally of maintaining a device state history, identifying a device usage pattern in dependence upon the device state history, and identifying a derived scenario in dependence upon the device usage pattern. The exemplary devices of FIG. 1 are also capable of identifying a workflow in dependence upon the derived scenario and executing the workflow in dependence upon a predetermined tolerance. The exemplary devices of FIG. 1 are also capable of identifying a user reaction to the execution of the workflow.

A device state history is a data structure containing the history of the values of one or more attributes of one or more devices. In the example of FIG. 1, each device may maintain its own device state history and store the device history in computer memory installed on the device or single device state history of all the devices in the network maybe maintained in computer memory accessible to application programming implementing workflow decision management that is installed on one or more devices.

A device usage pattern is typically implemented as a data structure representing a predetermined pattern of device usage for one or more devices. That is, a data structure representing a pattern of device usage. A device usage pattern may represent a pattern of usage of a single device or a pattern of usage of more than one device. The system of FIG. 1 typically identifies a device usage pattern in dependence upon the device state history by searching a plurality of stored device usage records for a device usage record that matches recent entries in the device state history.

The system of FIG. 1 is also capable of identifying a derived scenario in dependence upon the identified device usage pattern. A derived scenario is typically implemented as a data structure representing a particular state of devices in a networked environment. Derived scenarios are created in dependence upon actual past device usage within the networked environment and such derived scenarios often represent scenarios of device usage of more than one device. The system of FIG. 1 typically identifies a derived scenario by retrieving a derived scenario ID from a derived scenario table in dependence upon the identified device usage pattern ID.

The system of FIG. 1 is also capable of identifying a workflow in dependence upon the derived scenario and executing the workflow. A workflow is software implementing a device controlling action that when executed changes the values of one or more attributes of one or more devices. Executing workflows typically includes calling member methods in a CAL object for a device, downloading an OSGi bundle to a device, calling member methods in a device class, sending a message to a device, or any other method of executing a workflow as will occur to those of skill in the art.

The arrangement of devices making up the exemplary system illustrated in FIG. 1 is for explanation, not for limitation. Data processing systems useful according to various embodiments of the present invention may include additional servers, routers, other devices, and peer-to-peer architectures, not shown in FIG. 1, as will occur to those of skill in the art. Networks in such data processing systems may support many data communications protocols, including for example, CEBus, X-10, LonTalk, HomePlug, HAVi, TCP/IP, HTTP, WAP, and others as will occur to those of skill in the art. Various embodiments of the present invention may also be implemented in various computer environments such as for example CEBus, OSGi, and others that will occur to those of skill in the art. Although much of the present specification describes exemplary embodiments of the present invention with particular reference to CEBus, the such descriptions are for explanation not for limitation. In fact, many environments and frameworks support workflow decision management according to the present invention such as, for example, CEBus, HAVi, HomePlug, LonWorks, X-10, OSGi, as well as others that will occur to those of skill in the art, and all such environments and frameworks are within the scope of the present invention.

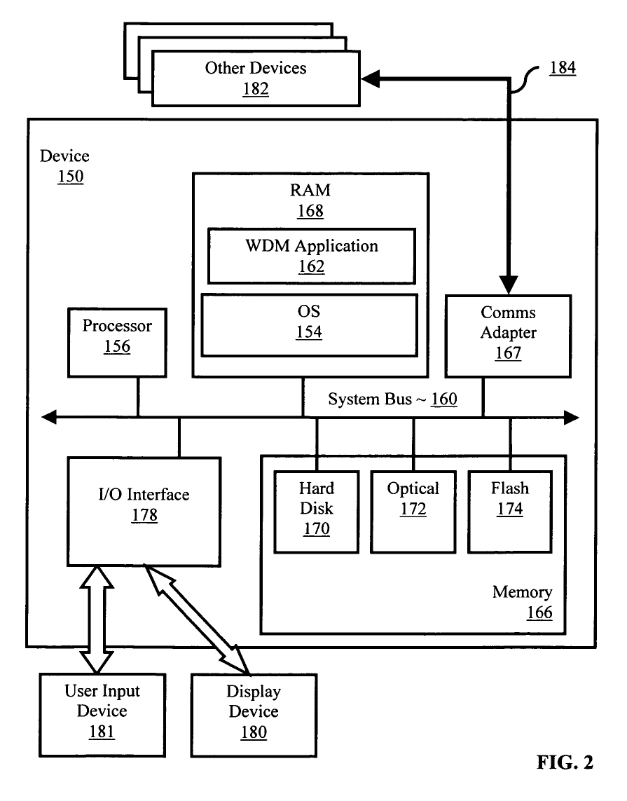

Workflow decision management in accordance with the present invention is generally implemented with automated computing machinery installed on one or more workflow decision management compliant devices. For further explanation, FIG. 2 sets forth a block diagram of an exemplary device (150) useful in implementing workflow decision management according to embodiments of the present invention. The device (150) of FIG. 2 includes at least one computer processor (156) or ‘CPU’ as well as random access memory (168) (“RAM”). Stored in RAM (168) is an operating system (154). Operating systems useful in computers according to embodiments of the present invention include Unix, Linux, Microsoft NTTM, and many others as will occur to those of skill in the art. Operating system (154) in the example of FIG. 2 is shown in RAM (168), but many components of an operating system typically are stored in non-volatile memory (166) also.

Also stored in RAM is a workflow decision management application (162). The workflow decision management application is application computer programming generally capable of maintaining a device state history, identifying a device usage pattern in dependence upon the device state history, and identifying a derived scenario in dependence upon the device usage pattern. The derived scenario typically has a tolerance governing the execution of workflows. The exemplary devices of FIG. 2 are also capable of identifying a workflow in dependence upon the derived scenario and executing the workflow in dependence upon the tolerance. Methods of workflow decision management in accordance with the present invention can be implemented using many programming languages including CAL, OSGi, Java, C++, Smalltalk, C, Pascal, Basic, COBOL, Fortran, and so on, as will occur to those of skill in the art.

The device (150) of FIG. 2 includes non-volatile computer memory (166) coupled through a system bus (160) to processor (156) and to other components of the device (150). Non-volatile computer memory (166) may be implemented as a hard disk drive (170), optical disk drive (172), electrically erasable programmable read-only memory space (so-called ‘EEPROM’ or ‘Flash’ memory) (174), RAM drives (not shown), or as any other kind of computer memory as will occur to those of skill in the art.

The exemplary device (150) of FIG. 2 includes a communications adapter (167) for implementing connections for data communications (184), including connections through networks, to other workflow management compliant devices (182), including servers, other workflow management client devices, and others as will occur to those of skill in the art. Communications adapters implement the hardware level of connections for data communications through which local devices and remote devices or servers send data communications directly to one another and through networks.

Examples of communications adapters useful for workflow decision management according to embodiments of the present invention include modems for wired dial-up connections, Ethernet (IEEE 802.3) adapters for wired LAN connections, and 802.11b adapters for wireless LAN connections.

The example device of FIG. 2 includes one or more input/output interface adapters (178). Input/output interface adapters in workflow management compliant devices implement user-oriented input/output through, for example, software drivers and computer hardware for controlling output to display devices (180) such as computer display screens, as well as user input from user input devices (181) such as keyboards and mice.

### Exemplary Data Structures Useful for Workflow Decision Management

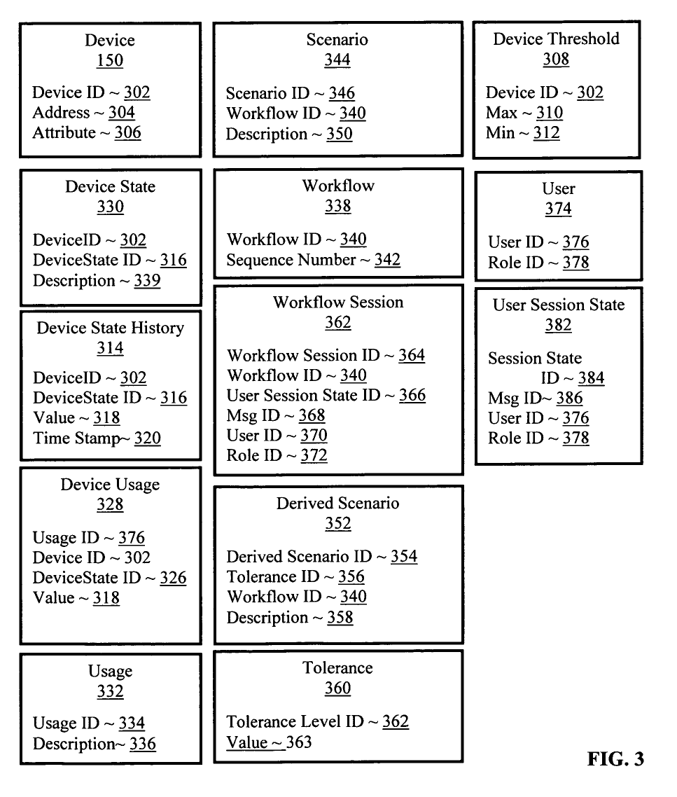

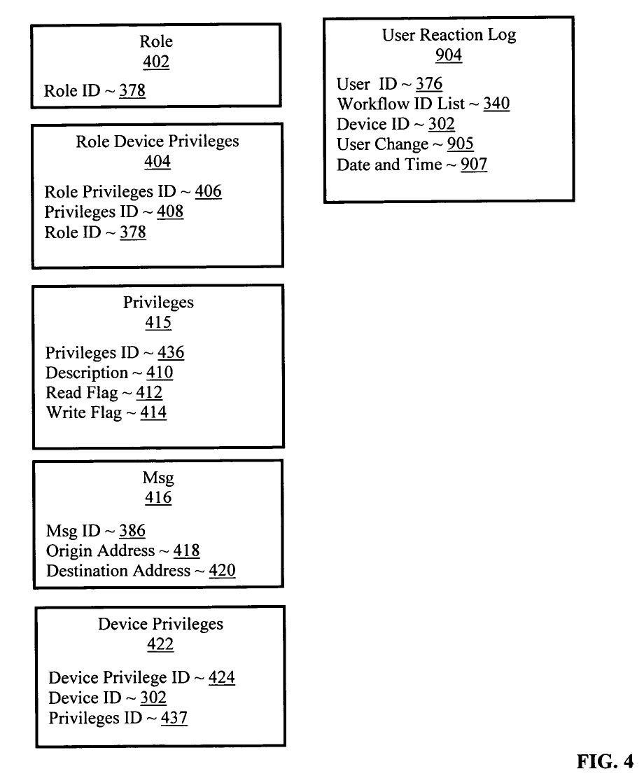

FIGS. 3 and 4 are block diagrams illustrating exemplary data structures useful in implementing methods of workflow decision management according to aspects of the present invention. In this specification, the terms “field” and “data element,” unless the context indicates otherwise, generally are used as synonyms, referring to individual elements of digital data. Aggregates of data elements are referred to as “records” or “data structures.” Aggregates of records are referred to as “tables” or “files.” Aggregates of files or tables are referred to as “databases.”

The example of FIG. 3 includes a device record (150) that represents a workflow decision management compliant device in accordance with the present invention. The exemplary device record (150) includes a device ID field (302) uniquely identifying the device. The exemplary device record (150) also includes an address field (304) containing the network address of the device. The exemplary device record (150) includes an attribute field (306). The attribute field contains the value of a particular attribute of a device indicating a device state such as on, off, a volume setting, and so on. Although only one attribute field is shown in the example of FIG. 3, this for simplicity of explanation. Many workflow decision management compliant devices support more than one attribute as will occur to those of skill in the art.

The example of FIG. 3 includes an exemplary device state record (330) that represents the allowable device states of a particular device. The device state record includes a device ID field (302) uniquely identifying the device for which the device state record represents acceptable device states. The device state record (330) also includes a device state ID field (316) uniquely identifying the device state. The device state record (330) also includes a description field (339) containing a description of the acceptable states or attribute values of the device.

The example of FIG. 3 includes a devices state history (314). The device state history is a data structure containing the history of the state of one or more devices. That is, the current as well as past values of attributes of a device. Records in the exemplary device state history (314) include a device ID (302) uniquely identifying the device for which the device state is recorded. Records of the exemplary device state history also include a device state ID field (316) uniquely identifying acceptable device states for the device. Records of the exemplary device state history (314) include a value field (318) containing the value of a particular attribute of the device. As stated above, typical devices support more than one attribute and therefore typical records of device state histories include a plurality of value fields containing the values of the supported attributes. Records of the exemplary device state history include a time stamp field (320) containing date and time information identifying the date and time that a particular device attribute of a particular device had a particular value.

The example of FIG. 3 includes a device usage record (328) that represents a predetermined pattern of device attributes for a device. That is, a device usage is a data structure used to identify whether the states of the devices in a particular networked environment conform to a predetermined pattern. To determine whether the state of current devices in a particular networked environment conform to a predetermined pattern, recent entries in the device state history compared with a plurality of device usage. If the comparison results in a match, it is inferred that the state of the devices in the particular networked environment conform to a predetermined pattern.

The exemplary devices usage (328) includes a usage ID (376) uniquely identifying a particular predetermined pattern of device usage. The exemplary device usage of FIG. 3 includes a device ID (302) uniquely identifying a particular device. The device usage (328) also includes a device state ID (326) uniquely identifying the acceptable device states for the particular device. The exemplary device usage (328) includes a value field (318) containing the value of a particular supported attribute of the device.

The example of FIG. 3 includes a usage record (332) that identifies and describes a particular pattern of device usage in the networked environment. The usage record (332) includes usage ID (334) that uniquely identifies the pattern of device usage, and a description field (336) that contains a description of the pattern of device usage represented by the usage record (332).

The example of FIG. 3 includes a scenario record (344) that represents a particular scenario of device usage consistent with an identified predetermined device usage pattern. Scenarios (344) are predetermined and predefined generally from many users in many networked environments. That is, they are not created from the actual device usage in the networked domain in which they are implemented. When the current states of a device conform to a predetermined pattern of device usage, the current states of a device may also conform to one of a plurality of scenarios. The exemplary scenario record (344) of FIG. 3 includes a scenario ID field (346) uniquely identifying the scenario. The exemplary scenario record (344) of FIG. 3 includes a workflow ID (340) identifying a workflow for execution when the current device states in a particular networked environment identify a scenario. Although the scenario record of FIG. 3 includes a single workflow ID field, this for simplicity of explanation, not for limitation. In many embodiments of the present invention, a particular scenario supports the execution of more than one workflow. The scenario (344) of FIG. 3 also contains a description field (350) that contains a description of the scenario.

The example of FIG. 3 includes a workflow record (338) that represents a particular device controlling action or a set of device controlling actions. A workflow is software implementing a device controlling action that when executed changes the values of one or more attributes of one or more devices in accordance with the present invention. The exemplary workflow record (338) includes a workflow ID (340) uniquely identifying the workflow. The exemplary workflow record (338) of FIG. 3 also includes a sequence field (342) identifying whose value is used to execute this workflow in a particular sequence of execution of a plurality of workflows. That is, when more than one workflow is executed for a scenario, the value of the sequence field is used to sequence the execution of the plurality of workflows. Workflows can be implemented using CAL, OSGi, Java, C++, Smalltalk, C, Pascal, Basic, COBOL, Fortran, and so on, as will occur to those of skill in the art.

The example of FIG. 3 includes a workflow session (362) that represents an instance of an executed workflow. The exemplary workflow session (362) includes a workflow session ID (364) uniquely identifying the workflow session and a workflow ID (340) identifying the executed workflow. The exemplary workflow session also includes a user session state ID (366) uniquely identifying the particular user session for which the workflow is executed. The exemplary workflow session also includes a message ID (368) identifying a message sent to a device to effect the workflow. That is the message send to a device instructing the device to change the value of a particular attribute. Sending such messages to the device, in some embodiments, effect changes in device status and therefore, carry out the workflow. The exemplary workflow session (362) includes a user ID (370) identifying the user on whose behalf the workflow is executed and a role ID field (372) identifying the security role of the user.

The example of FIG. 3 includes a derived scenario (352) that represents a particular scenario of device usage in the networked domain. Derived scenarios are created in dependence upon the actual device usage within the networked environment. Derived scenarios (352) have two important distinctions from scenarios (344). First, the derived scenarios are created in dependence upon the device usage of the devices within the networked environment and therefore reflect scenarios of device usage of the particular networked environment from which they are derived rather than canned or off the shelf scenarios. Second, derived scenarios have an associated tolerance (360) which is a rule set that governs the execution of workflows executed in dependence upon identifying the derived scenario.

The exemplary derived scenario (352) of FIG. 3 includes a derived scenario ID field (354) uniquely identifying the derived scenario. The exemplary derived scenario (352) of FIG. 3 includes a tolerance ID (356) identifying an associated tolerance for the derived scenario. The derived scenario (352) of FIG. 3 also includes a workflow ID (340) to be executed with the state of devices in the networked environment identify the derived scenario. The workflow is executed in dependence upon the associated tolerances of the derived scenario. The derived scenario (352) record contains a description field (358) containing a description of the derived scenario.

The example of FIG. 3 includes a tolerance record (360) that represents a rule set governing the execution of a workflow executed in dependence upon an identified derived scenario. Often a tolerance is a subset of the range of acceptable attribute values (363) that a device supports. For example, a thermostat may support attribute values that will if set will eventually damage either the thermostat itself or other devices. A tolerance is therefore often designed to govern the execution of workflows such that device usage is not harmful to devices within the networked environment. The exemplary tolerance (360) of FIG. 3 includes a tolerance level ID field (362) uniquely identifyng the tolerance.

The example of FIG. 3 includes a device threshold record (308) that represents the threshold minimum and threshold maximum attribute values that device will support. The exemplary device threshold record (308) of FIG. 3 includes a device ID (302) identifying the device for which the thresholds are valid. The exemplary device threshold record also includes MAX field (310) containing the maximum attribute value that the device will support and a MIN field (312) that includes the minimum attribute value that the device will support.

The example of FIG. 3 includes a user record (374) representing a user for which workflows are performed to affect device status. Users according to aspects of workflow decision management of the present invention are not limited to human users, but also include processes as will occur to those of skill in the art. The exemplary user record (374) of FIG. 3 includes a user ID (376) uniquely identifying the user and a role ID (378) uniquely representing the role of the user. A role is security role for the user such as a systems administrator, a guest, and so on.

The example of FIG. 3 also includes a user session state (382) that represents a session for a user. A session for a user indications current workflow decision management being executed on the user's behalf. The user session state (382) of FIG. 3 includes a session state ID (384) that uniquely identifies the user session state and a message ID (386) that identifies a message sent to give effect to a particular workflow identified in a workflow session and executed on behalf of the user. The user session state also includes a user ID (376) identifying the user on whose behalf the workflow is executed and a role ID (378) identifying the role of the user.

FIG. 4 is a block diagram of more data structures useful in workflow decision management according to embodiments of the present invention. The example of FIG. 4 includes a role record (402) that represents a security role for a user. The exemplary role record (402) of FIG. 4 includes a role ID (378) that uniquely identifies a security role.

The example of FIG. 4 includes a role device privileges record (404) that representing the privileges assigned to a particular role for a device. For example, some security roles have only limited access to some devices. The role device privileges record (404) includes a role privileges ID field (406) uniquely identifying the role device privileges. The exemplary role device privileges record (404) of FIG. 4 includes a privileges ID (408) identifying an allowable privilege and a role ID (378) identifying a particular security role having the privilege.

The example of FIG. 4 includes a privilege record (415) representing a particular privilege. The exemplary privilege record (415) includes a privilege ID field (436) identifying the privilege and a description field (410) containing a description of the privilege. The exemplary privilege record (415) includes a read flag (412) and a write flag (414) containing a Boolean indication of read and write privileges.

The example of FIG. 4 includes a message record (416) representing a message. The message record (416) includes a message ID field (386) uniquely representing the message. The example message (416) of FIG. 4 also includes an origin address field (418) containing the network address of the device originating the message and a destination address field (420) containing the network address of the device receiving the message.

The example of FIG. 4 includes a device privilege record (422) that represents an available privilege appropriate for a device. The exemplary device privilege record (422) of FIG. 4 includes a device privilege ID (424) uniquely identifying the device privilege and a device ID (302) identifying the device. The exemplary device privilege record (422) includes a privilege ID (437) identifying an privilege appropriate for the device.

The example of FIG. 4 includes a user reaction log (904) containing information representing a user's reaction to executing workflows. The user reaction log (904) of

FIG. 4 includes a user ID (476) field identifying the user. The user reaction log record of FIG. 4 also includes a workflow ID (340) that identifies the workflow to which a user reacted negatively. The user reaction log (904) of FIG. 4 also includes a device ID field (302) identifying the device that the user manually administered within some predetermined period of time of the execution of the workflow. The user reaction log also includes a user change field (905) that includes the change in attribute value of the device that the user manually administered. In many examples of the method of FIG. 4, such descriptions of changes are encoded in data structures containing the value of the attribute that results from the execution of the workflow, a value of the attribute some predetermined time after the execution of the workflow, and the difference between the values. In other examples of the method of FIG. 4, the attribute change encodes a change in a Boolean attribute such as “on” or “off.” In alternative embodiments, a description of the change in device attribute includes a text description of the change in device attribute, a sound recording describing the change in device attribute, or any other description of device change that will occur to those of skill in the art. Typical reaction log entries also advantageously includes a date and time field (907) that includes the date and time that user reaction was identified or the date and time that the change in device attribute was detected. Date and time information provides additional context for reviewing the reaction log. This additional date and time information facilitates a user's review of the reaction log and therefore, a user's ability to make informed decisions regarding editing the workflows administering devices on the user's behalf.

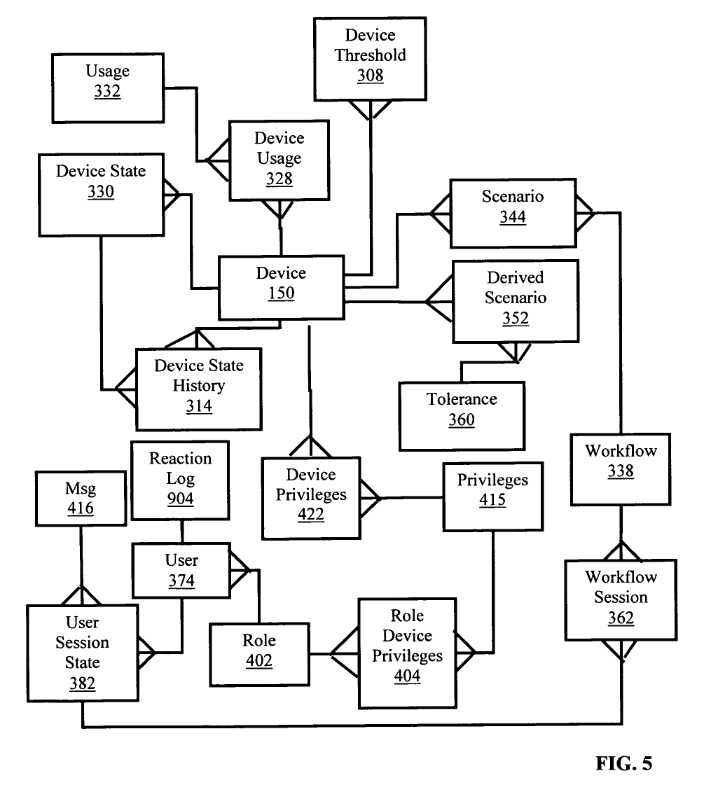

FIG. 5 is a block diagram illustrating an exemplary relationship among the data structures of FIGS. 3 and 4. In the example of FIG. 5, the device record is related one-to-many to the identified device usage record (328) through the device ID field (302 on FIG. 3) used as a foreign key. The identified device usage record (328) is related many-to-one to the usage record (332) through the usage ID field (376 on FIG. 3) used as a foreign key. The device record (150) is related one-to-many to the device threshold record (308) through the device ID field (302 on FIG. 3) used as a foreign key.

In the example of FIG. 5, the device record (150) is related one-to-many to the device state record (330) through the device ID field (302 on FIG. 3) used as a foreign key. The device state record (330) is related one-to-many to the device state history record (314) through the device state ID field (316 on FIG. 3) used as a foreign key. The device state history record (314) is related many-to-one to the device record (150) through the device ID field (302 on FIG. 3) used as a foreign key.

In the example of FIG. 5, the device record (150) is related one-to-many to the scenario record (344) through the device ID field (302 on FIG. 3) used as a foreign key. The scenario record (344) is related many-to-one to the workflow record (338) through a workflow ID field (340 on FIG. 3) used as a foreign key. The workflow record (338) is related one-to-many to the workflow session (362) through the workflow ID field (340 on FIG. 3) used as a foreign key.

In the example of FIG. 5, the device record (150) is related one-to-many to the derived scenario record (352) through the device ID field (302 on FIG. 3) used as a foreign key. The derived scenario record (352) is related many-to-one to the tolerance record (360) through the derived scenario ID field (354 on FIG. 3) used as a foreign key.

In the example of FIG. 5, the device record (150) is related one to many with the device privileges record (422) through the device ID field (302 on FIG. 3) used as a foreign key. The device privileges record (422) is related many-to-one through to the privileges record (415) through the privilege ID field (437 on FIG. 4) used as a foreign key. The privileges record (415) is related one-to-many to the role device privileges record (404) through the privilege ID field (436 on FIG. 4) used as a foreign key. The role device privileges record (404) is related many-to-one to the role record (402) through a role field (378 on FIG. 4) used as a foreign key.

In the example of FIG. 5, the user record (374) is related many-to-one through to the role record (402) through the role ID field (378 on FIG. 4) used as a foreign key. The user record (374) is related one-to-one to the user reaction log record (904) through the user ID field (376 on FIG. 3) used as a foreign key. The user record (374) is related to the user session state (382) one-to-many through the user ID field (376 on FIG. 4) used as a foreign key. In the example of FIG. 5, the user session state (382) is related many-to-one to the message record (416) through the message ID field (386 on FIG. 3) used as a foreign key. In the example of FIG. 5, the user session state (382) is related one-to-many to the workflow session (362) through the user session state ID (384 on FIG. 3) used as a foreign key.

### Workflow Decision Management with Derived Scenarios and Workflow Tolerances

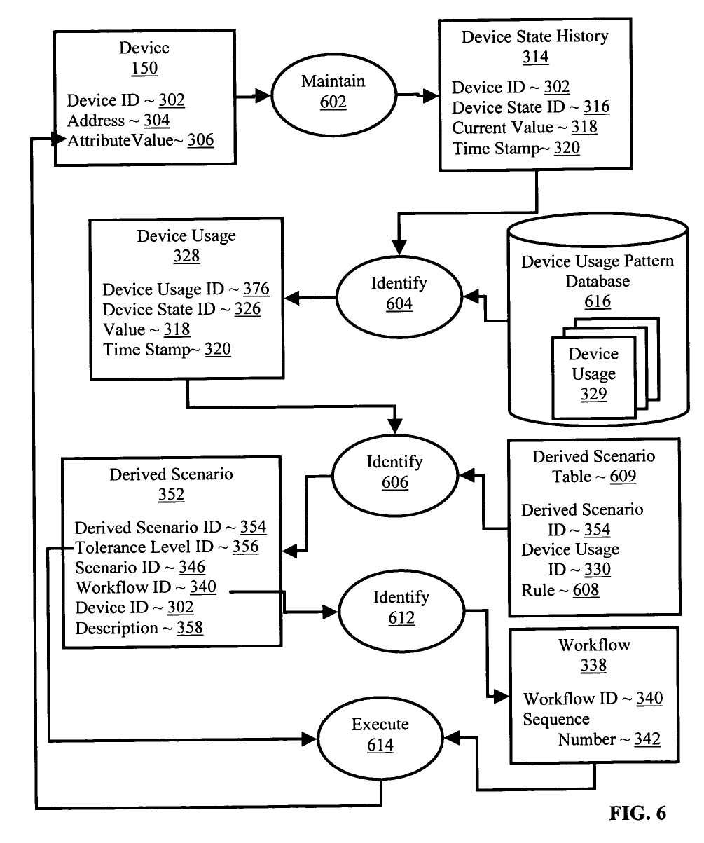

FIG. 6 sets forth a data flow diagram illustrating an exemplary method for workflow decision management. The method of FIG. 6 includes maintaining (602) a device state history (314). As discussed above, the device state history is a data structure containing the history of the values of one or more attributes of one or more devices. A device state history for a single device can be maintained in computer memory on the device itself or a single device state history for many devices in the networked environment can be maintained in computer memory accessible to application programming implementing the method of FIG. 6.

In the method of FIG. 6, maintaining (602) a device state history (314) includes recording a plurality of attribute values (306) for a device (150). In the example of FIG. 6, each time an attribute value (306) of a device (150) is changed, the change is recorded by creating a new entry in a device state history. In some such embodiments, the latest entry in the device state history (314) represents the current state of the device. In some embodiments, workflow decision management devices are configured to report to application programming implementing a device state manager with each change in an attribute value and the device state manager creates a new entry in a device state history recording the change in attribute value.

The method of FIG. 6 also includes identifying (604) a device usage pattern (328) in dependence upon the device state history (314). As discussed above, a device usage record represents a predetermined pattern of device usage and includes a collection of device attribute values defining the device usage pattern. In the method of FIG. 6, identifying (604) a device usage pattern (328) in dependence upon the device state history (314) further comprises comparing the device state history (314) with a plurality of device usage patterns records (329). In the example of FIG. 6, a window of the entries of the device state history (314) representing recent device states is compared with device usage records (329) in a device usage pattern database (616) to identify a matching an identified device usage record (328). If such a matching an identified device usage record (328) exists, then it is inferred that the current state of devices within a networked environment conform to a device usage pattern represented by the record.

As will occur to those of skill in the art, in typical embodiments, the values of the entries in the device state history do not have to be exactly the same as the values of the device usage records to identify a matching device usage record. In fact, the values of the entries of the device state history will often not be the exactly the same as the values of the device usage records when a matching record is identified. The degree to which the values of the entries in the device state history must be similar to the values of the device usage records to be considered a match will vary according to factors such as tolerances and methods used to used to compare the device state history with the device usage records, predefined tolerances for identifying a match, as well as other numerous factors that will occur to those of skill in the art.

The method of FIG. 6 also includes identifying (606) a derived scenario (352) having an associated tolerance (356) in dependence upon the identified device usage pattern (328). As discussed above, a derived scenario (352) represents a particular scenario created in dependence upon actual device usage within the networked environment. Derived scenarios (352) have two important distinctions from other canned scenarios. First, the derived scenarios are created in dependence upon the actual past device usage of the devices within the networked environment and therefore reflect scenarios of device usage of the particular networked environment. Second, in the example of FIG. 6, the derived scenarios (352) have an associated tolerance (356). A tolerance is a rule set governing the execution of workflows executed in dependence upon the identified derived scenario.

In the method of FIG. 6, identifying (606) a derived scenario (352) in dependence upon the identified device usage pattern (328) further comprises retrieving a derived scenario ID from a derived scenario table. In the example of FIG. 6 a derived scenario table (609) includes a plurality of derived scenario IDs (354) indexed by device usage IDs (330) identifying predefined device usage patterns. Identifying (606) a derived scenario (352) in dependence upon the identified device usage pattern (328) therefore includes retrieving a derived scenario ID from a derived scenario table in dependence upon the device usage ID (330) of the identified device usage record (328).

In the method of FIG. 6, identifying (606) a derived scenario (352) in dependence upon the identified device usage pattern (328) further comprises identifying a derived scenario (352) in dependence upon a rule (608). A rule (608) governs the identification of a particular derived scenario among a plurality of derived scenarios when more than one derived scenario associated with a single device usage pattern exists. Consider the example of a user cooking in a networked kitchen. The states of the devices in a living room match a device usage pattern that the user is cooking. However, more than one scenario corresponds with the device usage pattern as the user may be cooking breakfast, cooking lunch, or cooking supper. An exemplary rule identifying a scenario is: If time of day is between 4:30 p.m. and 7:30 p.m. and device usage pattern identifies a cooking scenario, then user is cooking supper.

The method of FIG. 6 also includes identifying (612) a workflow (338) in dependence upon the derived scenario (352). As discussed above, a workflow is software implementing a device controlling action that when executed changes the values of one or more attributes of one or more devices in accordance with the present invention. In the method of FIG. 6, identifying (612) a workflow (338) in dependence upon the derived scenario (352) comprises retrieving a workflow ID (340) from a derived scenario record (352).

The method of FIG. 6 also includes executing (614) the workflow (338) in dependence upon the tolerance (356). As discussed above, a tolerance represents a rule governing the execution of a workflow. Often a tolerance is a subset of the range of acceptable attribute values that a device supports. Such tolerances are often designed to prevent the execution of workflows from damaging devices within the networked environment.

In the method of FIG. 6, executing (614) the workflow (338) in dependence upon the tolerance (356) further comprises sending a message to a device instructing the device to change the value of an attribute. In some such examples, a device receiving such a method can effect the change in value of the device by calling a member methods in a device class representing the device such as, for example, SomeDeviceClass.setAtrribute( ) parameterized with an attribute value.

Consider the following example. A networked home has a number of devices that are used to cool the west wing of the home. These devices include a fan, an air conditioner, and automatic shades. However, the automatic shades are currently not working and they currently will not close properly. Workflow decision management according to the present invention has identified a scenario within a home network demonstrating that the west wing of the home is too warm and therefore identifies and executes a workflow to cool the home that includes reducing the thermostat for the air conditioner, increasing fan speed and closing the automatic shades.

Because the automatic shades are not working properly, the workflow does not reduce the temperature in the west wing sufficiently and soon thereafter the scenario that the room is too hot is again identified. The same workflow is again identified and executed. By providing a tolerance for the execution of the workflow that defines a minimum tolerance value allowed for the thermostat, the air conditioner is spared from being overworked to the point of damage. That is, tolerances provide some boundaries for the execution of workflow preventing devices from being damaged by unforeseen problems with the execution of a workflow, such as in this case, the automatic shades not working properly. These tolerance values are often designed as a subset of the actual values that devices support. Such design advantageously recognizes that devices often support attribute values that will ultimately lead to damaging the device.

### Workflow Decision Management Including Identifying User Reaction to Workflows

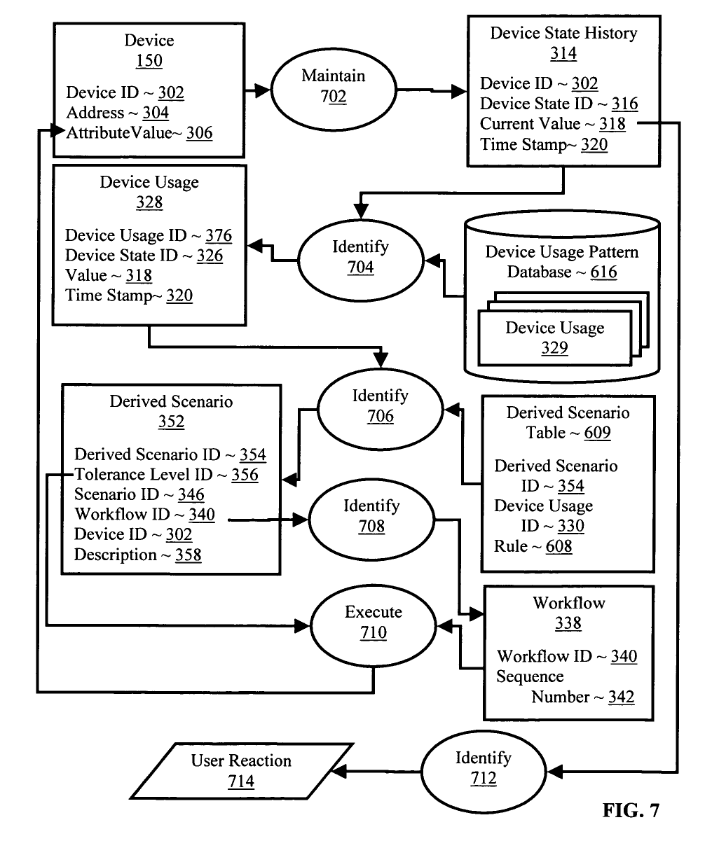

As discussed above, workflow decision management executes workflows resulting in the administration of one or more devices in a networked environment. It is not uncommon for different users to administer devices differently. Consequently, workflow decision management executed on behalf of one user may not result in administering devices in a manner favorable to another user. A user reacting unfavorably to the execution of a workflow may, after the execution of the workflow, manually administer a device in a manner more favorable to the user. For example, executing a workflow resulting in setting a thermostat to 79° Fahrenheit may not be favorable to a user who typically sets the thermostat to 72° Fahrenheit. The user's manually changing the setting of the thermostat after the execution of the workflow is itself an indication that the user did not react favorably to the workflow. The present section of this disclosure therefore provides a method for workflow decision management that includes identifying negative user reactions to a workflow beginning with reference to FIG. 7.

FIG. 7 sets forth a data flow diagram illustrating an exemplary method for workflow decision management that includes maintaining (702) a device state history (314). As discussed above, the device state history is a data structure containing the history of the values of one or more attributes of one or more devices. In the method of FIG. 7, maintaining (702) a device state history (314) typically includes recording a plurality of attribute values (306) for a device (150). In typical embodiments, each time an attribute value (306) of a device (150) is changed, the change is recorded by creating a new entry in a device state history. The latest entry for a device in the device state history (314) typically represents the current state of the device. In some embodiments, workflow decision management devices are configured to report to application programming implementing a device state manager with each change in an attribute value and the device state manager creates a new entry in a device state history recording the change in attribute value.

The method of FIG. 7 also includes identifying (704) a device usage pattern (328) in dependence upon the device state history (314). As discussed above, a device usage record represents a predetermined pattern of device usage and includes a collection of device attribute values defining the device usage pattern. In the method of FIG. 7, identifying (704) a device usage pattern (328) in dependence upon the device state history (314) is carried out by comparing the device state history (314) with a plurality of device usage patterns records (329). In the example of FIG. 7, a window of the entries of the device state history (314) representing recent device states is compared with device usage records (329) in a device usage pattern database (616) to identify a matching device usage record (328). If such a matching device usage record (328) exists, then the device usage pattern record is retrieved from the device usage pattern database.

As will occur to those of skill in the art, in typical embodiments, the values of the entries in the device state history do not have to be exactly the same as the values of the device usage records to identify a matching device usage record. In fact, the values of the entries of the device state history will often not be the exactly the same as the values of the device usage records when a matching record is identified. The degree to which the values of the entries in the device state history must be the same or similar to the values of the device usage records to be considered a match will vary according to factors such as tolerances and methods used to used to compare the device state history with the device usage records, predefined tolerances for identifying a match, as well as other numerous factors that will occur to those of skill in the art.

The method of FIG. 7 also includes identifying (706) a derived scenario (352) in dependence upon the device usage pattern (328). In the example of FIG. 7, the derived scenario (352) has a tolerance (356). As discussed above, a derived scenario (352) represents a particular scenario created in dependence upon actual device usage within the networked environment. Derived scenarios (352) have two important distinctions from other canned or off-the-shelf scenarios. First, the derived scenarios are created in dependence upon the actual past device usage of the devices within the networked environment and therefore reflect scenarios of device usage unique to the particular networked environment. Second, in the example of FIG. 7, the derived scenarios (352) have an associated tolerance (356). A tolerance is a rule set governing the execution of workflows executed in dependence upon the identified derived scenario.

In the method of FIG. 7, identifying (706) a derived scenario (352) in dependence upon the identified device usage pattern (328) is carried out by retrieving a derived scenario ID from a derived scenario table. In the example of FIG. 7 a derived scenario table (609) includes a plurality of derived scenario IDs (354) indexed by device usage IDs (330) identifying predefined device usage patterns. Identifying (706) a derived scenario (352) in dependence upon the identified device usage pattern (328) therefore includes retrieving a derived scenario ID from a derived scenario table in dependence upon the device usage ID (330) of the identified device usage record (328).

In the method of FIG. 7, identifying (706) a derived scenario (352) in dependence upon the identified device usage pattern (328) also includes identifying a derived scenario (352) in dependence upon a rule (608). A rule (608) governs the identification of a particular derived scenario among a plurality of derived scenarios when more than one derived scenario associated with a single device usage pattern exists. Consider the example of a user cooking in a networked kitchen. The states of the devices in a living room match a device usage pattern that defines a scenario of a user cooking. However, more than one scenario corresponds with the device usage pattern as the user may be cooking breakfast, cooking lunch, or cooking supper. An exemplary rule identifying a scenario is: If time of day is between 4:30 p.m. and 7:30 p.m. and device usage pattern identifies a cooking scenario, then user is cooking supper.

The method of FIG. 7 also includes identifying (708) a workflow (338) in dependence upon the derived scenario (352). As discussed above, a workflow is software implementing a device controlling action that when executed changes the values of one or more attributes of one or more devices in accordance with the present invention. In the method of FIG. 7, identifying (708) a workflow (338) in dependence upon the derived scenario (352) is carried out by retrieving a workflow ID (340) from a derived scenario record (352).

The method of FIG. 7 also includes executing (710) the workflow (338) in dependence upon the tolerance (356). As discussed above, a tolerance represents a rule governing the execution of a workflow. Often a tolerance is a subset of the range of acceptable attribute values that a device supports. Such tolerances are often designed to prevent the execution of workflows from damaging devices within the networked environment

The method of FIG. 7 also includes identifying (712) a user reaction (714) to the execution of the workflow (338). In many embodiments of the method of FIG. 7, identifying (712) a user reaction (714) to the execution of the workflow (338) includes waiting a predetermined period of time and detecting that a user manually administered one or more the devices that were administered by executing the workflow. That is, identifying (712) a user reaction (714) to the execution of the workflow (338) typically determining whether an attribute value of one or more the devices that were administered by executing the workflow has changed within some predetermined period of time. If the attribute value has changed, the fact that the device attribute has changed is considered a negative reaction of a user.

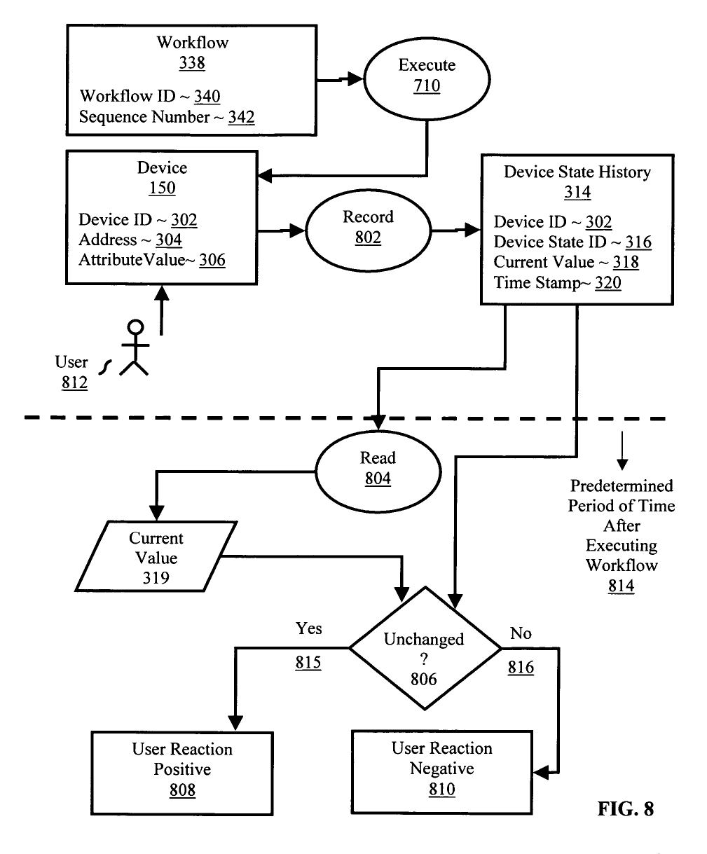

For further explanation, FIG. 8 sets forth a data flow diagram illustrating an exemplary method for identifying (712 on FIG. 7) a user reaction (714 on FIG. 7) to the execution of the workflow (338) that includes recording (802) in a device state history (314) a device attribute value (306) set by executing the workflow (338). As discussed above, each time an attribute value of a device is changed, the change is recorded by creating a new entry in a device state history. The latest entry for a device in the device state history often represents the current state of the device.

The method of FIG. 8 also includes reading (804) a current value of the device attribute (319) a predetermined period of time (814) after executing the workflow. In the example of the FIG. 8, reading (804) a current value of the device attribute (319) a predetermined period of time (814) after executing the workflow is carried out by reading the current value of the device attribute from the device state history (314). As discussed above, the current value of the device is often the latest entry for the device in the device state history. In alternative embodiments, reading (804) a current value of the device attribute (319) a predetermined period of time (814) after executing the workflow is carried out by polling the device itself some period of time after the execution of the workflow. Polling the device may be carried out by invoking member methods, such as getAttribute( ), in a device class representing the device.

The method of FIG. 8 also includes comparing (806) the device attribute value (318) set by executing the workflow (338) and the current value of the device attribute (319) a predetermined period of time (814) after executing the workflow. If the current value is unchanged (815), the user's reaction to the workflow is considered positive (808). If the current value (319) is not (816) unchanged, the user's reaction to the workflow is considered negative (810).

In various examples of the method of FIG. 8, the predetermined period of time after the execution of the workflow will vary. The time period is typically designed to be long enough to allow a user to experience the new device settings resulting from the execution of the workflow, and then alter the effect of the workflow by manually changing the value of an attribute of one or more of the devices administered by executing the workflow. The time period is also designed to be short enough so that a change in the value of the device attributes can be inferred as being the result of a user's experiencing the workflow and knowingly altering its effect by directly administering the device.

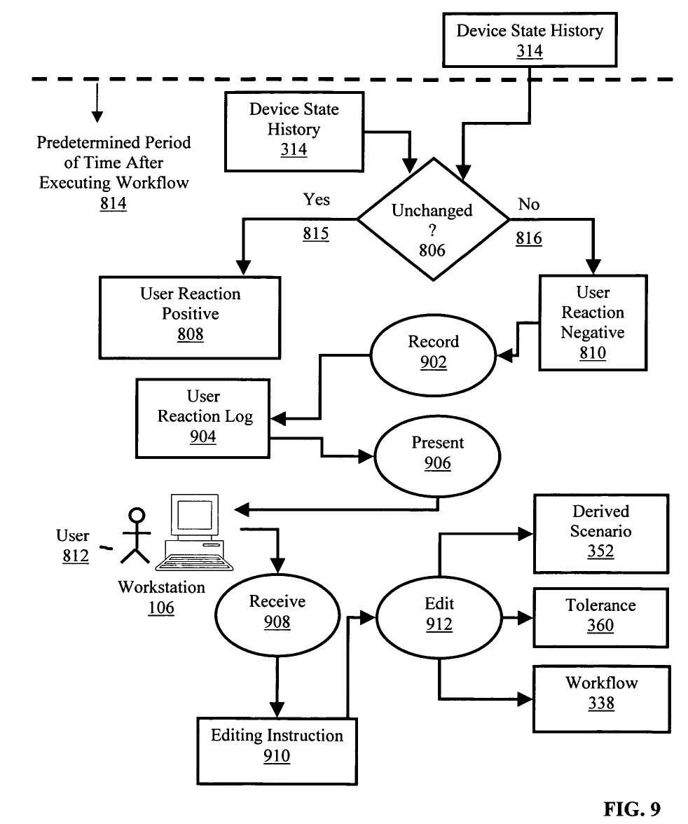

A user's negative reaction to the execution of a workflow may provide information useful to a user who desires to edit workflows, tolerances, or derived scenarios causing changes in device attributes to which the user reacts negatively. For further explanation therefore, FIG. 9 sets forth a method of workflow decision management that includes recording (902) an indication of a negative user reaction (810) in a user reaction log (904). A user reaction log (904) is a data structure that includes a plurality of indications of a user's negative reaction often indexed by device ID of the device that the user adjusted, and the time and date. A user reaction log provides a vehicle to succinctly display to the user a pattern of the user's reaction to the executions of one or more workflows. In some embodiments a user reaction log may also be indexed by particular workflow IDs often resulting negative reactions.

The method of FIG. 9 also includes presenting (906) the user reaction log (904) to a user (812). In the method of FIG. 9, presenting (906) the user reaction log (904) to a user (812) is typically carried out by a workflow decision management application providing user reaction log screens accessible by the user by use of a browser coupled for data communications with the workflow decision management application. In such embodiments, a user can access the user reaction log using a web browser installed on a computer, a PDA, a cell phone, or any other device, capable of allowing the user to view the user reaction log that will occur to those of skill in the art.

Viewing the entire user reaction log may be cumbersome for typical users. In some embodiments therefore, presenting (906) the user reaction log (904) to a user (812) also includes providing the user with a summary of the reaction log. Summaries of user reaction logs may include statistical summaries describing the contents of the user reaction log, summaries of the identified workflows and their individual actions organized by date and time, or any other summary of the user reaction log that will occur to those of skill in the art.

After reviewing the reaction log, a user may wish to change the way workflows are executed on the user's behalf. The method of FIG. 9 therefore also includes receiving (908) an editing instruction (910) from the user (812). Such an editing instruction may be an instructing to edit a tolerance (360), a workflow (338), or a derived scenario (352) or any other data structure affecting the execution of workflow decision management. Editing instructions are typically an instruction to delete or change one of the values in a derived scenario, a tolerance or a workflow.

Editing (912) a tolerance (360) typically includes changing the maximum and minimum values associated with a tolerance for a particular workflow to which the user reacted negatively. Editing (912) a workflow (338) typically includes changing the workflow ID in the derived scenario identified and giving rise to the execution of the workflow to which the user reacted negatively. Changing the workflow ID changes the workflow executed when the derived scenario is identified. Editing a derived scenario (352) typically includes changing the values of the derived scenario itself, such that when similar device usage patterns occur, that derived scenario is no longer identified and therefore, that workflow is not executed.

In the method of FIG. 9, receiving (908) an editing instruction (910) from the user (812) is typically carried out by use of instruction screens designed to facilitate receiving (908) an editing instruction (910) from the user (812). Such instruction screens are typically accessible by a user through the use of a browser coupled for data communications with the workflow decision management application. In such embodiments, a user can access the instruction screens using a web browser installed on a computer, a PDA, a cell phone, or any other device, capable of allowing the user to view the instruction screens that will occur to those of skill in the art.

It will be understood from the foregoing description that modifications and changes may be made in various embodiments of the present invention without departing from its true spirit. The descriptions in this specification are for purposes of illustration only and are not to be construed in a limiting sense. The scope of the present invention is limited only by the language of the following claims.

What is claimed is:

1. A method for workflow decision management, the method comprising:
maintaining a device state history;
identifying a device usage pattern in dependence upon the device state history;
identifying a derived scenario in dependence upon the device usage pattern;
wherein the derived scenario has a tolerance;
identifying a workflow in dependence upon the derived scenario;
executing the workflow in dependence upon the tolerance; and
identifying a user reaction to the execution of the workflow.

2. The method of claim 1 wherein identifying a user reaction to the execution of the workflow further comprises:
recording in a device state history a device attribute value set by executing the workflow;
reading a current value of the device attribute a predetermined period of time after executing the workflow; and
comparing the device attribute value set by executing the workflow and the current value of the device attribute a predetermined period of time after executing the workflow.

3. The method of claim 1 further comprising recording an indication of a negative user reaction in a user reaction log.

4. The method of claim 3 further comprising:
presenting the user reaction log to a user;
receiving an editing instruction from the user; and
editing a derived scenario in dependence upon the editing instruction.

5. The method of claim 3 further comprising:
presenting the user reaction log to a user;
receiving an editing instruction from the user; and
editing a tolerance in dependence upon the editing instruction.

6. The method of claim 3 further comprising:
presenting the user reaction log to a user;
receiving an editing instruction from the user; and
editing a workflow in dependence upon the editing instruction.

7. The method of claim 1 wherein maintaining a device state history further comprises recording a plurality of attribute values for a device.

8. The method of claim 1 wherein identifying a device usage pattern in dependence upon the device state history further comprises comparing the device state history with a plurality of device usage patterns records.

9. The method of claim 1 wherein identifying a derived scenario in dependence upon the device usage pattern further comprises retrieving a derived scenario ID from a derived scenario table.

10. A system for workflow decision management, the system comprising:
means for maintaining a device state history;
means for identifying a device usage pattern in dependence upon the device state history;
means for identifying a derived scenario in dependence upon the device usage pattern;
wherein the derived scenario has a tolerance;
means for identifying a workflow in dependence upon the derived scenario;
means for executing the workflow in dependence upon the tolerance; and
means for identifying a user reaction to the execution of the workflow.

11. The system of claim 10 wherein means for identifying a user reaction to the execution of the workflow further comprises:
means for recording in a device state history a device attribute value set by executing the workflow;
means for reading a current value of the device attribute a predetermined period of time after executing the workflow; and
means for comparing the device attribute value set by executing the workflow and the current value of the device attribute a predetermined period of time after executing the workflow.

12. The system of claim 10 further comprising means for recording an indication of a negative user reaction in a user reaction log.

13. The system of claim 12 further comprising:
means for presenting the user reaction log to a user;
means for receiving an editing instruction from the user; and
means for editing a derived scenario in dependence upon the editing instruction.

14. The system of claim 12 further comprising:
means for presenting the user reaction log to a user;
means for receiving an editing instruction from the user; and
means for editing a tolerance in dependence upon the editing instruction.

15. The system of claim 12 further comprising:
means for presenting the user reaction log to a user;
means for receiving an editing instruction from the user; and
means for editing a workflow in dependence upon the editing instruction.

16. The system of claim 10 wherein means for maintaining a device state history further comprises means for recording a plurality of attribute values for a device.

17. The system of claim 10 wherein means for identifying a device usage pattern in dependence upon the device state history further comprises means for comparing the device state history with a plurality of device usage patterns records.

18. The system of claim 10 wherein means for identifying a derived scenario in dependence upon the device usage pattern further comprises means for retrieving a derived scenario ID from a derived scenario table.

19. A computer program product for workflow decision management, the computer program product comprising:
a recording medium;
means, recorded on the recording medium, for maintaining a device state history;
means, recorded on the recording medium, for identifying a device usage pattern in dependence upon the device state history;
means, recorded on the recording medium, for identifying a derived scenario in dependence upon the device usage pattern;
wherein the derived scenario has a tolerance;
means, recorded on the recording medium, for identifying a workflow in dependence upon the derived scenario;
means, recorded on the recording medium, for executing the workflow in dependence upon the tolerance; and
means, recorded on the recording medium, for identifying a user reaction to the execution of the workflow.

20. The computer program product of claim 19 wherein means, recorded on the recording medium, for identifying a user reaction to the execution of the workflow further comprises:
means, recorded on the recording medium, for recording in a device state history a device attribute value set by executing the workflow;
means, recorded on the recording medium, for reading a current value of the device attribute a predetermined period of time after executing the workflow; and
means, recorded on the recording medium, for comparing the device attribute value set by executing the workflow and the current value of the device attribute a predetermined period of time after executing the workflow.

21. The computer program product of claim 19 further comprising means, recorded on the recording medium, for recording an indication of a negative user reaction in a user reaction log.

22. The computer program product of claim 21 further comprising:
means, recorded on the recording medium, for presenting the user reaction log to a user;
means, recorded on the recording medium, for receiving an editing instruction from the user; and
means, recorded on the recording medium, for editing a derived scenario in dependence upon the editing instruction.

23. The computer program product of claim 21 further comprising:
means, recorded on the recording medium, for presenting the user reaction log to a user;
means, recorded on the recording medium, for receiving an editing instruction from the user; and
means, recorded on the recording medium, for editing a tolerance in dependence upon the editing instruction.

24. The computer program product of claim 21 further comprising:
means, recorded on the recording medium, for presenting the user reaction log to a user;
means, recorded on the recording medium, for receiving an editing instruction from the user; and
means, recorded on the recording medium, for editing a workflow in dependence upon the editing instruction.

25. The computer program product of claim 19 wherein means, recorded on the recording medium, for maintaining a device state history further comprises means, recorded on the recording medium, for recording a plurality of attribute values for a device.

26. The computer program product of claim 19 wherein means, recorded on the recording medium, for identifying a device usage pattern in dependence upon the device state history further comprises means, recorded on the recording medium, for comparing the device state history with a plurality of device usage patterns records.

27. The computer program product of claim 19 wherein means, recorded on the recording medium, for identifying a derived scenario in dependence upon the device usage pattern further comprises means, recorded on the recording medium, for retrieving a derived scenario ID from a derived scenario table.
